(19) United States
(12) Patent Application Publication
(10) Pub. No.: US 2016/0033347 A1
(43) Pub. Date: Feb. 4, 2016

(54) PHYSICAL QUANTITY SENSOR, PRESSURE SENSOR, ALTIMETER, ELECTRONIC DEVICE, AND MOVING OBJECT

(71) Applicant: Seiko Epson Corporation, Tokyo (JP)

(72) Inventor: Kazuya HAYASHI, Fujimi (JP)

(21) Appl. No.: 14/810,768

(22) Filed: Jul. 28, 2015

(30) Foreign Application Priority Data
Jul. 29, 2014 (JP) 2014-153665
Jul. 29, 2014 (JP) 2014-153666

(51) Int. Cl. G01L 7/08; G01L 9/08

(52) U.S. Cl. CPC G01L 7/08; G01L 9/08

(57) ABSTRACT

A physical quantity sensor includes a substrate that includes a recessed portion which is open on one face of the substrate, a diaphragm portion that includes a bottom portion of the recessed portion and is flexibly deformed by receiving pressure, a piezoresistive element that is arranged in the diaphragm portion, and a stepped portion that is arranged along the periphery of the diaphragm portion on the other face of the substrate and protrudes from the diaphragm portion in the thickness direction of the diaphragm portion by a height which is smaller than the depth of the recessed portion.

### BACKGROUND

1. Technical Field

The present invention relates to a physical quantity sensor, a pressure sensor, an altimeter, an electronic device, and a moving object.

2. Related Art

A pressure sensor that is provided with a diaphragm which is flexibly deformed by receiving pressure (for example, refer to JP-A-2011-75400) is widely used. Generally, such a pressure sensor detects pressure applied to the diaphragm by detecting the flexure of the diaphragm with a sensor element arranged on the diaphragm.

The diaphragm used in the pressure sensor is generally configured by, as disclosed in JP-A-2011-75400, forming a recessed portion on one face of a substrate and using the part that is thinned by the recessed portion of the substrate. The sensor element that detects the flexure of the diaphragm is arranged on the opposite face of the substrate from the face on which the recessed portion is open.

Recently, there has been a demand for reducing the size of the pressure sensor. However, in the pressure sensor according to JP-A-2011-75400, a problem arises in that it is difficult to realize sufficient detection sensitivity when the size of the diaphragm is reduced.

### SUMMARY

An advantage of some aspects of the invention is to provide a physical quantity sensor that has excellent detection sensitivity and to provide a pressure sensor, an altimeter, an electronic device, and a moving object that are provided with the physical quantity sensor.

The invention can be implemented as the following application examples.

### APPLICATION EXAMPLE 1

A physical quantity sensor according to this application example includes a substrate that includes a recessed portion which is open on one face side of the substrate, a diaphragm portion that includes a bottom portion of the recessed portion and is flexibly deformed by receiving pressure, a sensor element that is arranged in the diaphragm portion, and a stepped portion that is arranged along the periphery of the diaphragm portion on the other face side of the substrate, the stepped portion protrudes from the diaphragm portion in the thickness direction of the diaphragm portion, and an amount of protrusion is less than the depth of the recessed portion.

According to the physical quantity sensor, stress can be concentrated on a boundary part between the diaphragm portion and the stepped portion when the diaphragm portion is flexibly deformed by receiving pressure. Therefore, arranging the sensor element at the boundary part can improve detection sensitivity.

### APPLICATION EXAMPLE 2

In the physical quantity sensor according to the application example, it is preferable that the face on the one face side of the diaphragm portion is a pressure receiving face.

With this configuration, a pressure reference chamber and the stepped portion can be easily formed on the opposite face of the substrate from the face on which the recessed portion is open by using a semiconductor manufacturing process.

### APPLICATION EXAMPLE 3

In the physical quantity sensor according to the application example, it is preferable that the sensor element is arranged further on the other face side than the thickness-wise center of the diaphragm portion.

With this configuration, the sensor element can be arranged at the part of the diaphragm portion where stress is concentrated by reception of pressure, and as a result, detection sensitivity can be improved. In addition, the sensor element can be formed accurately and in a simple manner when compared with a case where the sensor element is arranged on the face of the substrate where the recessed portion is open.

### APPLICATION EXAMPLE 4

In the physical quantity sensor according to the application example, it is preferable that the sensor element is arranged further on the stepped portion side than the center of the diaphragm portion.

With this configuration, the sensor element can be arranged at the part of the diaphragm portion where stress is concentrated by reception of pressure, and as a result, detection sensitivity can be improved.

### APPLICATION EXAMPLE 5

In the physical quantity sensor according to the application example, it is preferable that the stepped portion is configured as a separate layer from the substrate.

With this configuration, the stepped portion can be formed to have an appropriate height accurately and in a simple manner.

### APPLICATION EXAMPLE 6

In the physical quantity sensor according to the application example, it is preferable that the separate layer includes polycrystalline silicon.

With this configuration, the stepped portion can be formed by using deposition accurately and in a simple manner. In addition, the difference in the linear expansion coefficient between the stepped portion and the diaphragm portion can be decreased when the diaphragm portion is formed by using a silicon substrate. As a result, the physical quantity sensor can have excellent temperature characteristics.

### APPLICATION EXAMPLE 7

In the physical quantity sensor according to the application example, it is preferable that the physical quantity sensor further includes a pressure reference chamber that is arranged on the other face side of the substrate.

With this configuration, pressure can be detected with the pressure inside the pressure reference chamber as a reference. In addition, the pressure reference chamber can be easily formed on the opposite face of the substrate from the face on which the recessed portion is open by using a semiconductor manufacturing process.

### APPLICATION EXAMPLE 8

In the physical quantity sensor according to the application example, it is preferable that a side wall portion of the pressure reference chamber is connected to the separate layer.

With this configuration, a gap is not formed between the stepped portion and the side wall portion of the pressure reference chamber, and an unintended behavior of etching liquid that is used when the pressure reference chamber is formed through sacrificial layer etching can be reduced.

### APPLICATION EXAMPLE 9

In the physical quantity sensor according to the application example, it is preferable that the amount of protrusion of the stepped portion is within the inclusive range of 0.1 μm to 380 μm.

With this configuration, stress can be effectively concentrated on the boundary part between the diaphragm portion and the stepped portion when the diaphragm portion is flexibly deformed by receiving pressure.

### APPLICATION EXAMPLE 10

In the physical quantity sensor according to the application example, it is preferable that the thickness of the diaphragm portion is within the inclusive range of 1 μm to 8 μm.

With this configuration, stress can be effectively concentrated on the boundary part between the diaphragm portion and the stepped portion when the diaphragm portion is flexibly deformed by receiving pressure.

### APPLICATION EXAMPLE 11

In the physical quantity sensor according to the application example, it is preferable that the stepped portion is at a position within the inclusive range of −5 μm to 15 μm toward the center of the diaphragm portion from the peripheral edge of the diaphragm portion as a reference.

According to the physical quantity sensor, stress can be concentrated on the boundary part between the diaphragm portion and the stepped portion when the diaphragm portion is flexibly deformed by receiving pressure. Therefore, arranging the sensor element at the boundary part can improve detection sensitivity.

### APPLICATION EXAMPLE 12

In the physical quantity sensor according to the application example, it is preferable that the width of the diaphragm portion is within the inclusive range of 50 μm to 300 μm.

With this configuration, stress can be effectively concentrated on the boundary part between the diaphragm portion and the stepped portion when the diaphragm portion is flexibly deformed by receiving pressure.

### APPLICATION EXAMPLE 13

A pressure sensor according to this application example includes the physical quantity sensor according to the application example.

With this configuration, a pressure sensor having excellent detection sensitivity can be provided.

### APPLICATION EXAMPLE 14

An altimeter according to this application example includes the physical quantity sensor according to the application example.

With this configuration, an altimeter that is provided with the physical quantity sensor having excellent detection sensitivity can be provided.

### APPLICATION EXAMPLE 15

An electronic device according to this application example includes the physical quantity sensor according to the application example.

With this configuration, an electronic device that is provided with the physical quantity sensor having excellent detection sensitivity can be provided.

### APPLICATION EXAMPLE 16

A moving object according to this application example includes the physical quantity sensor according to the application example.

With this configuration, a moving object that is provided with the physical quantity sensor having excellent detection sensitivity can be provided.

### BRIEF DESCRIPTION OF THE DRAWINGS

Embodiments of the invention will be described with reference to the accompanying drawings, wherein like numbers reference like elements.

FIG. 1 is a cross-sectional view illustrating a physical quantity sensor according to a first embodiment of the invention.

FIG. 2 is an enlarged plan view illustrating the arrangement of a piezoresistive element in the physical quantity sensor illustrated in FIG. 1.

FIGS. 3A and 3B are diagrams for describing the action of the physical quantity sensor illustrated in FIG. 1. FIG. 3A is a cross-sectional view illustrating an increased pressure state of the physical quantity sensor, and FIG. 3B is a plan view illustrating the increased pressure state of the physical quantity sensor.

FIGS. 4A to 4C are schematic diagrams for describing a stepped portion with which the physical quantity sensor illustrated in FIG. 1 is provided.

FIG. 5 is a graph illustrating a relationship between detection sensitivity and the height of the stepped portion.

FIG. 6 is a graph illustrating a relationship between detection sensitivity and the position of an end of the stepped portion.

FIGS. 7A to 7D are diagrams illustrating a manufacturing process for the physical quantity sensor illustrated in FIG. 1.

FIGS. 8A to 8C are diagrams illustrating the manufacturing process for the physical quantity sensor illustrated in FIG. 1.

FIG. 9 is an enlarged plan view illustrating the arrangement of the piezoresistive element in a physical quantity sensor according to a second embodiment of the invention.

FIG. 10 is a cross-sectional view illustrating an example of a pressure sensor according to the invention.

FIG. 11 is a perspective view illustrating an example of an altimeter according to the invention.

FIG. 12 is a front view illustrating an example of an electronic device according to the invention.

FIG. 13 is a perspective view illustrating an example of a moving object according to the invention.

### DESCRIPTION OF EXEMPLARY EMBODIMENTS

Hereinafter, detailed descriptions will be provided for a physical quantity sensor, a pressure sensor, an altimeter, an electronic device, and a moving object according to the invention as based on each embodiment illustrated in the appended drawings.

### 1. Physical Quantity Sensor

### First Embodiment

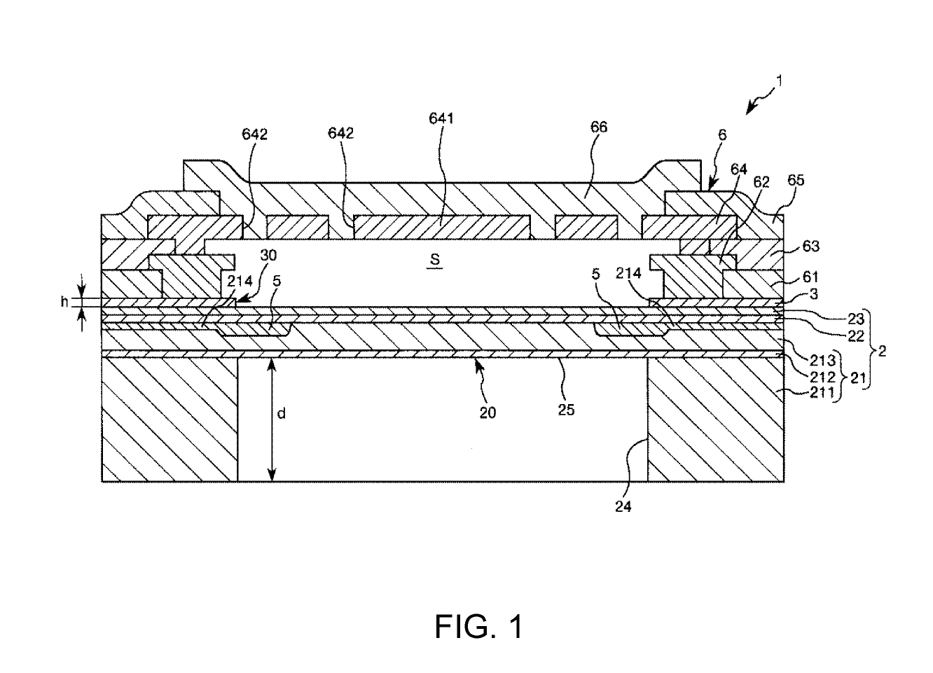

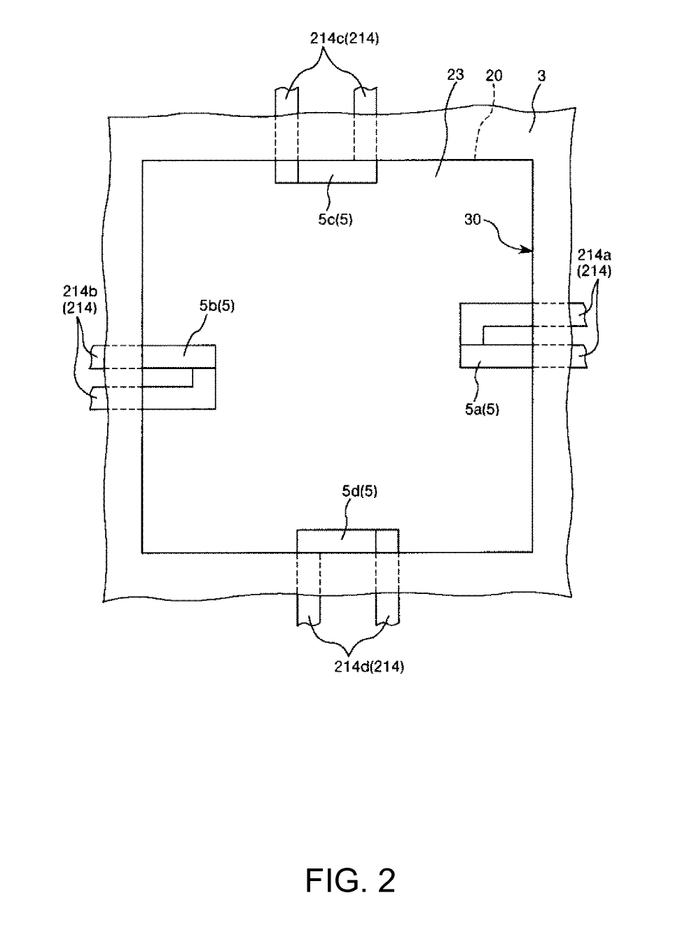

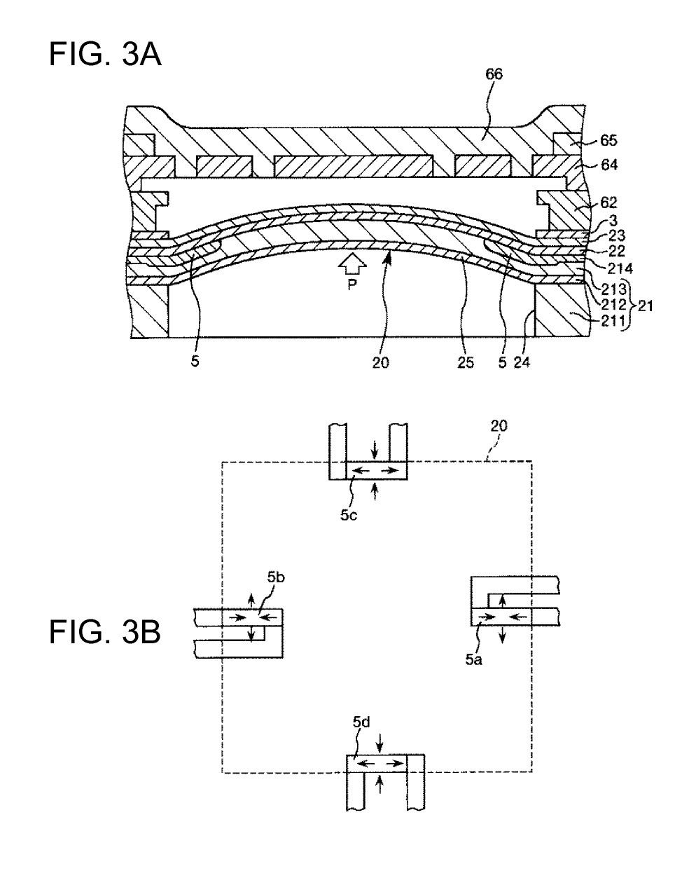

FIG. 1 is a cross-sectional view illustrating a physical quantity sensor according to a first embodiment of the invention. FIG. 2 is an enlarged plan view of the arrangement of a piezoresistive element in the physical quantity sensor illustrated in FIG. 1. FIGS. 3A and 3B are diagrams for describing the action of the physical quantity sensor illustrated in FIG. 1. FIG. 3A is a cross-sectional view illustrating an increased pressure state of the physical quantity sensor, and FIG. 3B is a plan view illustrating the increased pressure state of the physical quantity sensor. Hereinafter, the upper part of FIG. 1 is “up”, and the lower part is “down” for convenience of description.

A physical quantity sensor 1 illustrated in FIG. 1 is provided with a substrate 2 that includes a diaphragm portion 20, a plurality of piezoresistive elements 5 (sensor elements) that are arranged in the diaphragm portion 20, a laminated structure 6 that forms a cavity portion S (pressure reference chamber) along with the diaphragm portion 20, and a step forming layer 3 that is arranged between the substrate 2 and the laminated structure 6.

Hereinafter, each unit constituting the physical quantity sensor 1 will be described in order.

### Substrate

The substrate 2 includes a semiconductor substrate 21, an insulating film 22 that is disposed on one face of the semiconductor substrate 21, and an insulating film 23 that is disposed on the opposite face of the insulating film 22 than the semiconductor substrate 21.

The semiconductor substrate 21 is an SOI substrate in which a silicon layer 211 (handle layer) that is configured of monocrystalline silicon, a silicon oxide layer 212 (box layer) that is configured by a silicon oxide film, and a silicon layer 213 (device layer) that is configured of monocrystalline silicon are laminated in this order. The semiconductor substrate 21 is not limited to an SOI substrate and may be a different semiconductor substrate such as a monocrystalline silicon substrate.

The insulating film 22 is, for example, a silicon oxide film and has insulating characteristics. The insulating film 23 is, for example, a silicon nitride film, has insulating characteristics, and has tolerance to etching liquid that includes hydrofluoric acid. By interposing the insulating film 22 (silicon oxide film) between the semiconductor substrate 21 (silicon layer 213) and the insulating film 23 (silicon nitride film), the insulating film 22 can alleviate propagation of stress that is generated at the time of deposition of the insulating film 23 to the semiconductor substrate 21. The insulating film 22 can also be used as an inter-element separating film when the semiconductor substrate 21 and a semiconductor circuit thereon are formed. The materials of the insulating films 22 and 23 are not limited to the above ones, and either one of the insulating films 22 and 23 may be omitted when desired.

The step forming layer 3 that is patterned is arranged on the insulating film 23 of the substrate 2. The step forming layer 3 is formed to surround the diaphragm portion 20 in a plan view. The step forming layer 3 forms a stepped portion 30 having the thickness of the step forming layer 3 between the upper face of the step forming layer 3 and the upper face of the substrate 2. The stepped portion 30 faces toward the center (interior or inside) of the diaphragm portion 20.

The step forming layer 3 is configured of, for example, monocrystalline silicon, polycrystalline silicon (polysilicon), or amorphous silicon. The step forming layer 3 may be configured by, for example, doping (through diffusion or implantation) monocrystalline silicon, polycrystalline silicon (polysilicon), or amorphous silicon with an impurity such as phosphorus or boron. In this case, the step forming layer 3 has conductivity. Therefore, apart of the step forming layer 3 can be used as the gate electrode of an MOS transistor when, for example, the MOS transistor is formed on the substrate 2 outside the cavity portion S. A part of the step forming layer 3 can also be used as wiring. The stepped portion 30 will be described in greater detail later.

The diaphragm portion 20 of the substrate 2 is thinner than the surrounding part of the substrate 2 and is flexibly deformed by receiving pressure. The diaphragm portion 20 cooperates with a recessed portion 24 on the lower face of the semiconductor substrate 21. That is, the diaphragm portion 20 is configured to form the bottom of the recessed portion 24 that is open at one face of the substrate 2. The lower surface (face) of the diaphragm portion 20 is a pressure receiving face 25. In the present embodiment, the diaphragm portion 20 has a square planar shape as illustrated in FIG. 2.

In the substrate 2 of the present embodiment, the recessed portion 24 passes through the silicon layer 211, and the diaphragm portion 20 is configured by the four layers of the silicon oxide layer 212, the silicon layer 213, the insulating film 22, and the insulating film 23. As will be described later, the silicon oxide layer 212 can be used as an etch stop layer when the recessed portion 24 is formed through etching in a manufacturing process for the physical quantity sensor 1. This can reduce variations in the thickness of the diaphragm portion 20 for each product.

If desired, the recessed portion 24 may not pass entirely through the silicon layer 211. Rather, the diaphragm portion 20 may be configured of the five layers of a thinned portion of the silicon layer 211, the silicon oxide layer 212, the silicon layer 213, the insulating film 22, and the insulating film 23.

### Piezoresistive Element

Each of the plurality of piezoresistive elements 5 is formed further on the cavity portion S side from the thickness-wise center of the diaphragm portion 20 as illustrated in FIG. 1. That is, the piezoresistive elements 5 are offset towards the cavity portion S relative to the center of the diaphragm portion 20. The piezoresistive elements 5 are formed in the silicon layer 213 of the semiconductor substrate 21.

The piezoresistive elements 5 are configured by piezoresistive elements 5a, 5b, 5c, and 5d that are arranged in the peripheral portion of the diaphragm portion 20 as illustrated in FIG. 2.

The piezoresistive element 5a, the piezoresistive element 5b, the piezoresistive element 5c, and the piezoresistive element 5d are arranged to correspond to each of the four edges of the diaphragm portion 20 that is a quadrangle in a plan view from above the thickness direction of the substrate 2 (hereinafter, simply referred to as a “plan view”).

The piezoresistive element 5a extends along a direction perpendicular to the corresponding edge of the diaphragm portion 20. A pair of wiring systems 214a is electrically connected to both end portions of the piezoresistive element 5a. Similarly, the piezoresistive element 5b extends along a direction perpendicular to the corresponding edge of the diaphragm portion 20. A pair of wiring systems 214b is electrically connected to both end portions of the piezoresistive element 5b.

The piezoresistive element 5c, meanwhile, extends along a direction parallel to the corresponding edge of the diaphragm portion 20. A pair of wiring systems 214c is electrically connected to both end portions of the piezoresistive element 5c. Similarly, the piezoresistive element 5d extends along a direction parallel to the corresponding edge of the diaphragm portion 20. A pair of wiring systems 214d is electrically connected to both end portions of the piezoresistive element 5d.

Hereinafter, the wiring systems 214a, 214b, 214c, and 214d may be collectively referred to as a “wiring system 214”.

Each of the piezoresistive elements 5 and the wiring system 214 are configured of silicon (monocrystalline silicon) that is doped (through diffusion or implantation) with an impurity such as phosphorus or boron. The doping concentration of the impurity in the wiring system 214 is higher than the doping concentration of the impurity in the piezoresistive elements 5. The wiring system 214 may be configured of metal.

The piezoresistive elements 5 are, for example, configured to have the same resistance value in a natural state.

The piezoresistive elements 5 described so far constitute a bridge circuit (Wheatstone bridge circuit) through the wiring system 214 and the like. A drive circuit (not illustrated) that supplies a drive voltage is connected to the bridge circuit. The bridge circuit outputs a signal (voltage) that corresponds to the resistance values of the piezoresistive elements 5.

### Laminated Structure

The laminated structure 6 is formed to define the cavity portion S between the laminated structure 6 and the above substrate 2. The laminated structure 6 is a “wall portion” that is arranged on the piezoresistive elements 5 side of the diaphragm portion 20 and constitutes the cavity portion S (pressure reference chamber) with the diaphragm portion 20.

The laminated structure 6 includes an inter-layer insulating film 61, a wiring layer 62, an inter-layer insulating film 63, a wiring layer 64, a surface protective film 65, and a seal layer 66. The inter-layer insulating film 61 is formed on the substrate 2 to surround the piezoresistive elements 5 in a plan view. The wiring layer 62 is formed on the inter-layer insulating film 61. The inter-layer insulating film 63 is formed on the wiring layer 62 and the inter-layer insulating film 61. The wiring layer 64 is formed on the inter-layer insulating film 63 and includes a cladding layer 641 that is provided with a plurality of pores 642 (open holes). The surface protective film 65 is formed on the wiring layer 64 and the inter-layer insulating film 63. The seal layer 66 is disposed on the cladding layer 641.

Each of the inter-layer insulating films 61 and 63 is configured by, for example, a silicon oxide film. Each of the wiring layer 62, the wiring layer 64, and the seal layer 66 is configured of metal such as aluminum. The seal layer 66 seals the pores 642 that the cladding layer 641 includes. The surface protective film 65 is, for example, a silicon nitride film. Each of the wiring layers 62 and 64 includes a part that is formed to surround the cavity portion S in a plan view.

The laminated structure 6 can be formed by using a semiconductor manufacturing process such as a CMOS process. A semiconductor circuit may be fabricated on and above the silicon layer 213. The semiconductor circuit includes active elements such as an MOS transistor and other circuit elements that are formed when necessary, such as a capacitor, an inductor, a resistor, a diode, and a wiring system (including the wiring systems connected to the piezoresistive elements 5).

The cavity portion S that is defined by the substrate 2 and the laminated structure 6 is an airtight space. The cavity portion S functions as a pressure reference chamber that serves to provide a reference value for pressure detected by the physical quantity sensor 1. In the present embodiment, the cavity portion S is in a vacuum state (less than or equal to 300 Pa). By causing the cavity portion S to be in a vacuum state, the physical quantity sensor 1 can be used as an “absolute pressure sensor” that detects pressure with a vacuum state as a reference, and thus the convenience of use of the physical quantity sensor 1 is improved.

If desired, the cavity portion S may not be in a vacuum state. The cavity portion S may be under atmospheric pressure, may be in a decreased pressure state where pressure is below atmospheric pressure, or may be in an increased pressure state where pressure is over atmospheric pressure. An inert gas such as a nitrogen gas and a noble gas may be sealed in the cavity portion S.

The configuration of the physical quantity sensor 1 has been briefly described so far.

In the physical quantity sensor 1 having the above configuration, pressure that the pressure receiving face 25 of the diaphragm portion 20 receives deforms the diaphragm portion 20 as illustrated in FIG. 3A. This causes the piezoresistive elements 5a, 5b, 5c, and 5d to be strained as illustrated in FIG. 3B, and the resistance values of the piezoresistive elements 5a, 5b, 5c, and 5d are changed. Accordingly, the output of the bridge circuit configured by the piezoresistive elements 5a, 5b, 5c, and 5d is changed, and the magnitude of the pressure received on the pressure receiving face 25 can be obtained on the basis of the output.

More specifically, the product of the resistance values of the piezoresistive elements 5a and 5b is the same as the product of the resistance values of the piezoresistive elements 5c and 5d in a natural state before the diaphragm portion 20 is deformed as described above, such as when the piezoresistive elements 5a, 5b, 5c, and 5d have the same resistance value. Thus, the output (potential difference) of the bridge circuit is zero.

Meanwhile, when the diaphragm portion 20 is deformed as described above, compressive strains and tensile strains occur respectively along the longitudinal direction and the widthwise direction of the piezoresistive elements 5a and 5b, and tensile strains and compressive strains occur respectively along the longitudinal direction and the widthwise direction of the piezoresistive elements 5c and 5d as illustrated in FIG. 3B. Therefore, one of the resistance values of the piezoresistive elements 5a and 5b and the resistance values of the piezoresistive elements 5c and 5d is increased, and the other is decreased when the diaphragm portion 20 is deformed as described above.

Such strain exerted on the piezoresistive elements 5a, 5b, 5c, and 5d causes a difference between the product of the resistance values of the piezoresistive elements 5a and 5b and the product of the resistance values of the piezoresistive elements 5c and 5d, and the output (potential difference) corresponding to the difference is output from the bridge circuit. The magnitude of the pressure (absolute pressure) received on the pressure receiving face 25 can be obtained on the basis of the output from the bridge circuit.

The difference between the product of the resistance values of the piezoresistive elements 5a and 5b and the product of the resistance values of the piezoresistive elements 5c and 5d can be significantly changed because one of the resistance values of the piezoresistive elements 5a and 5b and the resistance values of the piezoresistive elements 5c and 5d is increased, and the other is decreased when the diaphragm portion 20 is deformed as described above. Accordingly, the output from the bridge circuit can be increased. As a result, pressure detection sensitivity can be increased.

### Stepped Portion

Hereinafter, the stepped portion 30 will be described in detail.

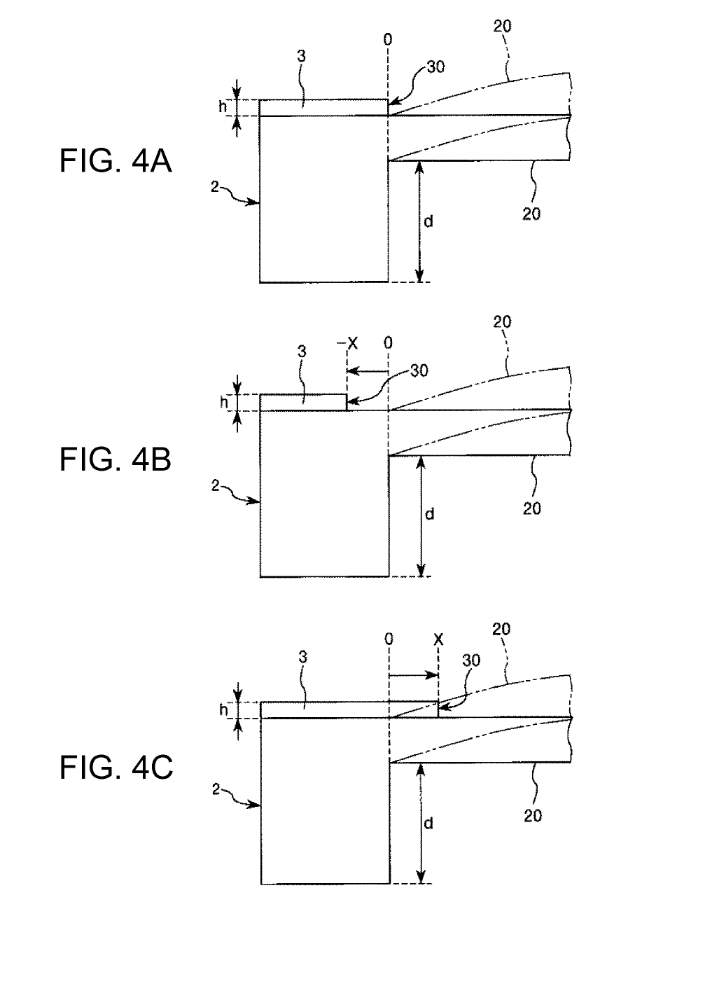

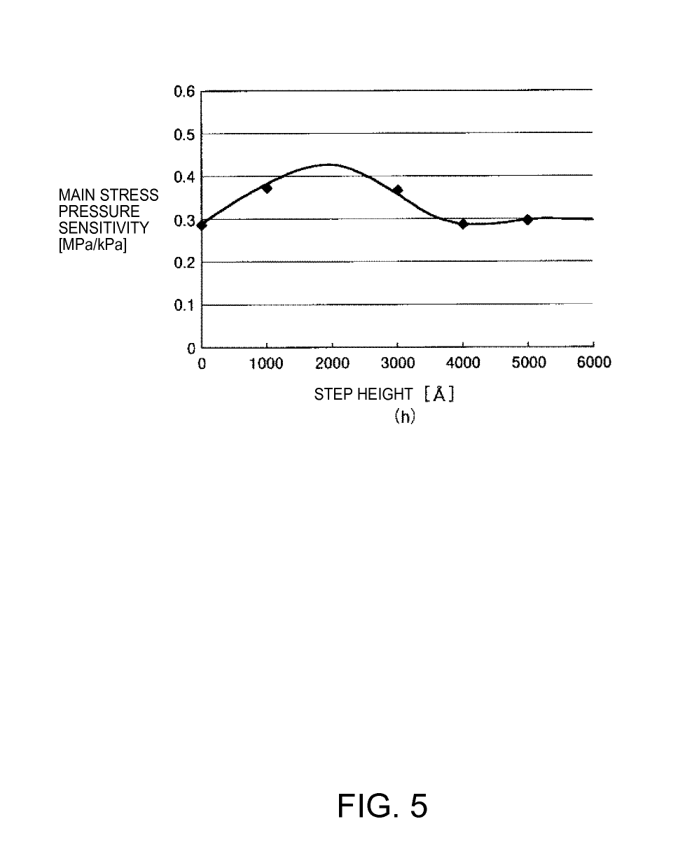

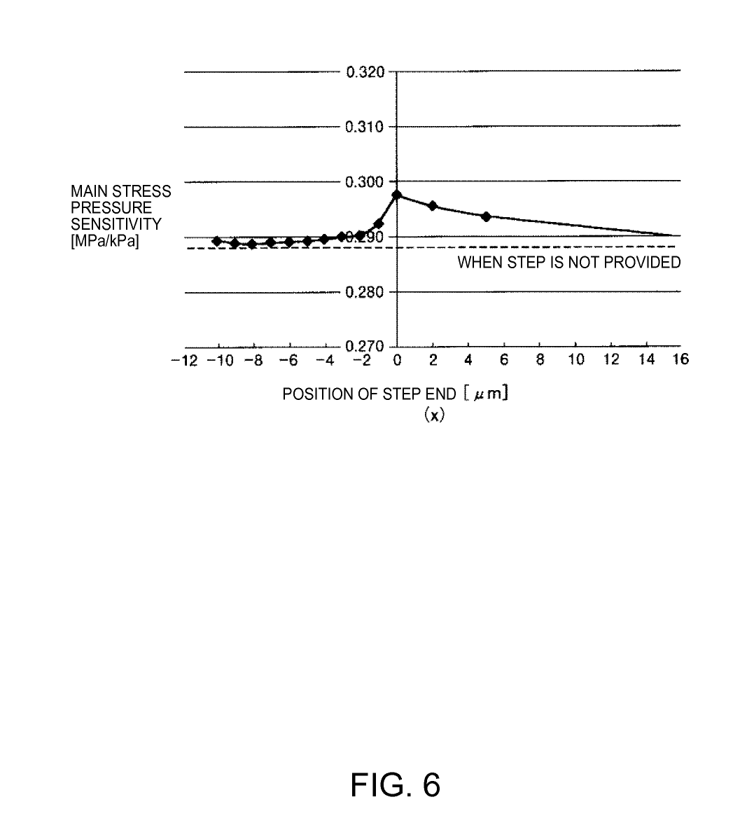

FIGS. 4A to 4C are schematic diagrams for describing the stepped portion with which the physical quantity sensor illustrated in FIG. 1 is provided. FIG. 5 is a graph illustrating a relationship between detection sensitivity and the height of the stepped portion. FIG. 6 is a graph illustrating a relationship between detection sensitivity and the position of an end of the stepped portion.

The stepped portion 30, as described above, is formed by the step forming layer 3 that is arranged on the substrate 2. The stepped portion 30 is arranged along the periphery of the diaphragm portion 20 on the upper face side of the substrate 2. In the present embodiment, the stepped portion 30 is arranged across the entire peripheral area of the diaphragm portion 20. While the amount of overlap among the stepped portion 30 and the peripheral portion of the diaphragm portion 20 is illustrated as being constant across the entire periphery of the diaphragm portion 20 in a plan view in FIG. 2, the amount of overlap may be varied at a part of the diaphragm portion 20 if desired.

The stepped portion 30, as illustrated in FIGS. 4A to 4C, protrudes relative to the diaphragm portion 20 in the thickness direction (toward the upper side) of the diaphragm portion 20, and a height h (amount of protrusion) of the stepped portion 30 is less than a depth d of the recessed portion 24. By arranging the stepped portion 30 in the vicinity of the periphery of the diaphragm portion 20, stress can be concentrated on the boundary part between the diaphragm portion 20 and the stepped portion 30 when the diaphragm portion 20 is flexibly deformed by receiving pressure as illustrated by a double-dot chain line in FIGS. 4A to 4C (refer to FIG. 4A). Thus, arranging the piezoresistive elements 5 at the boundary part (or near the boundary part) can improve detection sensitivity.

Regarding the step forming layer 3, the height h of the stepped portion 30 is comparatively small, and a position X of an inboard edge surface of the stepped portion 30 is in the vicinity of the periphery of the diaphragm portion 20. This allows the flexible deformation of the diaphragm portion 20 to the desired extent when the diaphragm portion 20 receives pressure and concentrates stress on the peripheral portion or the vicinity of the diaphragm portion 20 when the diaphragm portion 20 receives pressure. In other words, the step forming layer 3 efficiently concentrates stress on the peripheral portion or the vicinity of the diaphragm portion 20 by appropriately regulating the flexible deformation of the diaphragm portion 20 caused by reception of pressure when the diaphragm portion 20 receives pressure.

Detection sensitivity is improved when the height h of the stepped portion 30 is less than or equal to 3800 Å (less than or equal to 380 μm) as illustrated in FIG. 5, when compared with a case where the stepped portion 30 is not provided. In the result illustrated in FIG. 5, detection sensitivity is improved to the maximum extent when the height h of the stepped portion 30 is 2000 Å (200 μm). From the result illustrated in FIG. 5, while the height h of the stepped portion 30 may desirably be within the inclusive range of 1 Å to 3800 Å (380 μm), the height h is preferably between 1000 Å and 3000 Å inclusive (between 100 μm and 300 μm inclusive) and more preferably between 1500 Å and 2500 Å inclusive (between 150 μm and 250 μm inclusive). Accordingly, stress can be effectively concentrated on the boundary part between the diaphragm portion 20 and the stepped portion 30 when the diaphragm portion 20 is flexibly deformed by receiving pressure. As a result, even if the size of the diaphragm portion 20 is reduced, excellent detection sensitivity can be realized.

The graph illustrated in FIG. 5 is the simulation result of a case where the step forming layer 3 is configured of polysilicon, the position X of the stepped portion 30 with the peripheral position of the diaphragm portion 20 as a reference (hereinafter, simply referred to as the “position X of the stepped portion 30”) is 0 μm, the width of the diaphragm portion 20 (the distance from the edge portion of the diaphragm portion 20 to the facing edge portion in a plan view) is 150 μm, and the thickness of the diaphragm portion 20 is 3 μm. The “position X of the stepped portion 30” is a position relative to the center of the diaphragm portion 20 from the peripheral edge of the diaphragm portion 20 (the position “0” in FIGS. 4A-4C) as a reference and is the position of the stepped portion 30 (inside end edge of the step forming layer 3) when the center side of the diaphragm portion 20 with respect to the peripheral edge of the diaphragm portion 20 is given “+” (a positive direction), and the outside of the diaphragm portion 20 is given “−” (a negative direction). The “main stress pressure sensitivity” in FIG. 5 is detection sensitivity that is based on the part where stress is the greatest on the upper face of the diaphragm portion 20 when the diaphragm portion 20 receives pressure. The position “0” is aligned with an interior surface of the substrate bordering the recess portion 24.

Regarding this matter, when the height h of the stepped portion 30 is excessively small, it is difficult to effectively concentrate the stress that results from the flexible deformation of the diaphragm portion 20 caused by reception of pressure, depending on the material and the modulus of elasticity of the step forming layer 3, the position X of the stepped portion 30, and the like. Also, the effect of improving detection sensitivity tends to be significantly decreased. Meanwhile, when the height h of the stepped portion 30 is excessively great, the flexible deformation of the diaphragm portion 20 caused by reception of pressure is impeded, depending on the material and the modulus of elasticity of the step forming layer 3, the position X of the stepped portion 30, and the like, and detection sensitivity is decreased.

Detection sensitivity is effectively improved when the position X of the stepped portion 30 is between −5 μm and 15 μm inclusive as illustrated in FIG. 6, when compared with a case where the stepped portion 30 is not disposed. From the result illustrated in FIG. 6, while the position X of the stepped portion 30 may desirably be between −5 μm and 15 μm inclusive, the position X is preferably between −2 μm and 15 μm inclusive, more preferably between −1 μm and 10 μm inclusive, and further preferably between −0.5 μm and 5 μm inclusive. Accordingly, stress can be effectively concentrated on the boundary part between the diaphragm portion 20 and the stepped portion 30 when the diaphragm portion 20 is flexibly deformed by receiving pressure. As a result, even if the size of the diaphragm portion 20 is reduced, excellent detection sensitivity can be realized.

The graph illustrated in FIG. 6 is the simulation result of a case where the step forming layer 3 is configured of polysilicon, the height h of the stepped portion 30 is 3000 Å (300 μm), the width of the diaphragm portion 20 (the distance from the edge portion of the diaphragm portion 20 to the facing edge portion in a plan view) is 150 μm, and the thickness of the diaphragm portion 20 is 3 μm. The “main stress pressure sensitivity” in FIG. 6 is detection sensitivity that is based on the part where stress is the greatest on the upper face of the diaphragm portion 20 when the diaphragm portion 20 receives pressure.

Regarding this matter, when the position X of the stepped portion 30 is excessively small, it is difficult to effectively concentrate the stress that results from the flexible deformation of the diaphragm portion 20 caused by reception of pressure, and the effect of improving detection sensitivity tends to be significantly decreased (refer to FIG. 4B). Meanwhile, when the position X of the stepped portion is excessively great, the flexible deformation of the diaphragm portion 20 caused by reception of pressure is impeded, depending on the material and the modulus of elasticity of the step forming layer 3, the height h of the stepped portion 30, and the like, and detection sensitivity is decreased (refer to FIG. 4C).

It is apparent from the results illustrated in FIG. 5 and FIG. 6 that the same result as the result illustrated in FIG. 5 is obtained when the position X of the stepped portion 30 is within the above range, and the same result as the result illustrated in FIG. 6 is obtained when the height h of the stepped portion 30 is within the above range. In addition, it is confirmed by simulation that the same results as the results illustrated in FIG. 5 and FIG. 6 are also obtained when the thickness of the diaphragm portion 20 is within the inclusive range of 1 μm to 8 μm or when the width of the diaphragm portion 20 is within the inclusive range of 50 μm to 300 μm.

The thickness of the diaphragm portion 20, therefore, is preferably within the inclusive range of 1 μm to 8 μm, and the width of the diaphragm portion 20 is preferably within the inclusive range of 50 μm to 300 μm. In other words, the thickness of the diaphragm portion 20 is preferably between three times and 27 times the height h of the stepped portion 30 inclusive, and the width of the diaphragm portion 20 is preferably between 160 times and 1000 times the height h of the stepped portion 30 inclusive. Accordingly, stress can be effectively concentrated on the boundary part between the diaphragm portion 20 and the stepped portion 30 when the diaphragm portion 20 is flexibly deformed by receiving pressure.

The stepped portion 30 can be formed to have an appropriate height accurately and in a simple manner because the stepped portion 30 is configured by the step forming layer 3 that is a separate layer from the substrate 2. Particularly, by configuring the step forming layer 3 of polycrystalline silicon, the stepped portion 30 can be formed accurately and in a simple manner by using deposition. In addition, if the step forming layer 3 is configured of polycrystalline silicon, the difference in the linear expansion coefficient between the stepped portion 30 and the diaphragm portion 20 can be decreased when the diaphragm portion 20 is formed by using a silicon substrate. As a result, the physical quantity sensor 1 can have excellent temperature characteristics.

The material of the step forming layer 3 may be monocrystalline silicon or amorphous silicon as described above or may be a material other than silicon but is preferably a material of which the linear expansion coefficient and the Young's modulus are close to those of the main material of the substrate 2 (monocrystalline silicon). Specifically, the linear expansion coefficient of the material of the step forming layer 3 is preferably between 1×10⁻⁷/K⁻¹ and 1×10⁻⁵/K⁻¹ inclusive, more preferably between 1×10⁻⁶/K⁻¹ and 1×10⁻⁵/K⁻¹ inclusive, and further preferably between 1×10⁻⁶/K⁻¹ and 5×10⁻⁶/K⁻¹ inclusive. The Young's modulus of the material of the step forming layer 3 is preferably between 1×10¹⁰ Pa and 1×10¹² Pa inclusive and more preferably between 5×10¹⁰ Pa and 5×10¹¹ Pa inclusive.

In the physical quantity sensor 1 that includes the stepped portion 30, the piezoresistive elements 5 are arranged further on the opposite side of the diaphragm portion 20 from the pressure receiving face 25 than the thickness-wise center of the diaphragm portion 20 and exist aside from the center of the diaphragm portion 20 toward the stepped portion 30. That is, the piezoresistive elements 5 are arranged in the diaphragm portion 20 near the stepped portion 30. Accordingly, the piezoresistive elements 5 can be arranged at the part of the diaphragm portion 20 where stress is concentrated by reception of pressure, and as a result, detection sensitivity can be improved. In addition, the piezoresistive elements 5 can be formed accurately and in a simple manner when compared with a case where piezoresistive elements (sensor elements) are arranged on the face of the substrate 2 where the recessed portion 24 is open.

The piezoresistive elements 5 may desirably be arranged at the part of the diaphragm portion 20 where stress is concentrated by reception of pressure or in the vicinity of the part as described above. Specifically, the piezoresistive elements 5 are preferably arranged in the area of a distance within 10 μm from the stepped portion 30 to the center of the diaphragm portion 20.

The cavity portion S and the stepped portion 30 can be easily formed on the opposite face of the substrate 2 from the face on which the recessed portion 24 is open by, as described above, using the lower face of the diaphragm portion 20 as the pressure receiving face 25 and arranging the cavity portion S on the upper face side of the substrate 2 through a semiconductor manufacturing process as will be described in detail later.

Since, as illustrated in FIG. 1, the side wall portion of the cavity portion S (the part of the wiring layers 62 and 64 surrounding the cavity portion S in a plan view) is connected to the upper face of the step forming layer 3, a gap is not formed between the stepped portion 30 and the side wall portion of the cavity portion S, and an unintended behavior of etching liquid that is used when the cavity portion S is formed through later-described sacrificial layer etching can be reduced.

### Method for Manufacturing Physical Quantity Sensor

Next, a method for manufacturing the physical quantity sensor 1 will be briefly described.

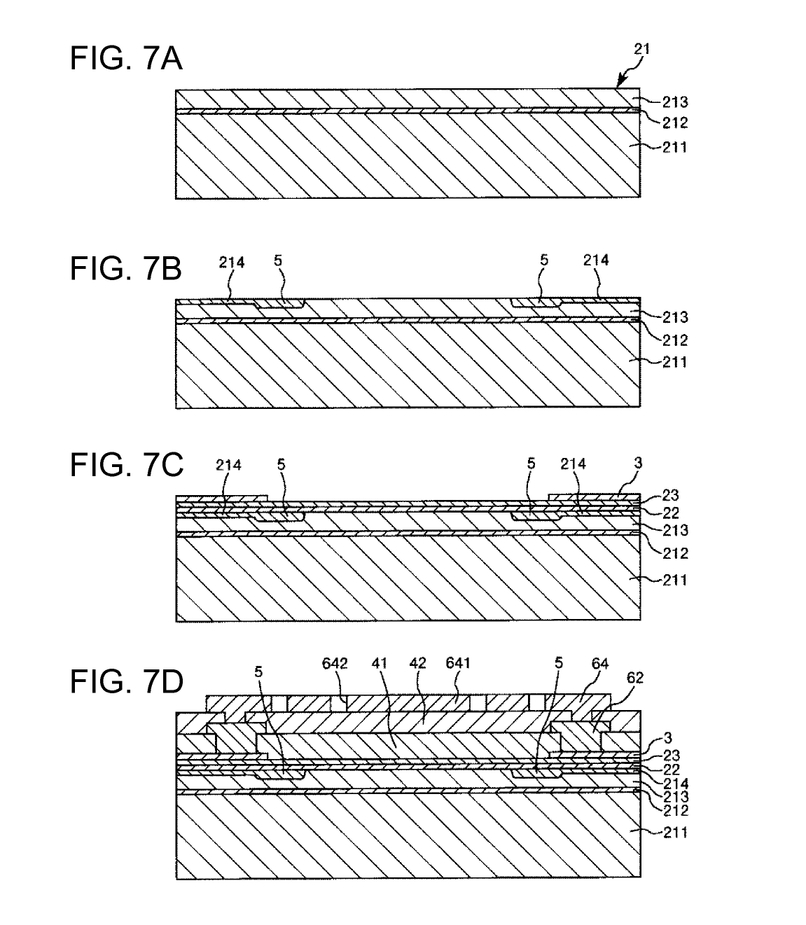

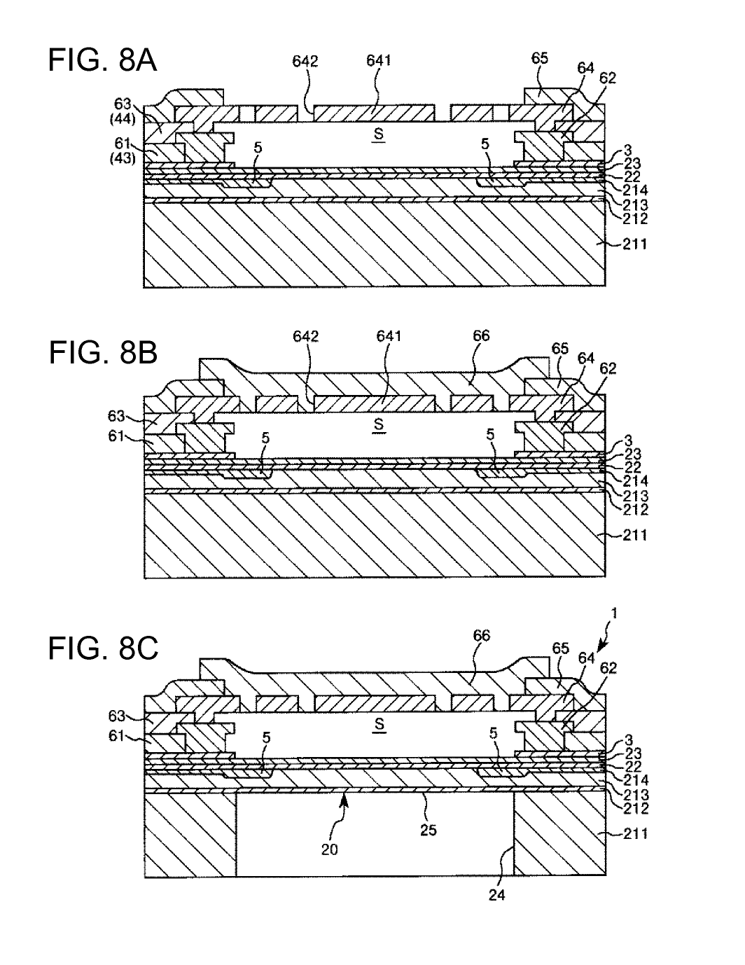

FIGS. 7A to 7D and FIGS. 8A to 8C are diagrams illustrating a manufacturing process for the physical quantity sensor illustrated in FIG. 1. Hereinafter, the method for manufacturing the physical quantity sensor 1 will be described on the basis of these drawings.

### Strain Detecting Element Forming Process

First, the semiconductor substrate 21 that is an SOI substrate is prepared as illustrated in FIG. 7A.

The plurality of piezoresistive elements 5 and the wiring system 214 are formed as illustrated in FIG. 7B by doping (through ion implantation) the silicon layer 213 of the semiconductor substrate 21 with an impurity such as phosphorus (n-type) or boron (p-type).

The concentration of the ions implanted into the piezoresistive elements 5 is approximately 1×10¹⁴ atoms/cm² when, for example, boron ions are implanted at an energy of +80 keV. The concentration of the ions implanted into the wiring system 214 is greater than the concentration of the ions implanted into the piezoresistive elements 5. The concentration of the ions implanted into the wiring system. 214 is approximately 5×10²⁵ atoms/cm² when, for example, boron ions are implanted at an energy of 10 keV. After the ions are implanted as described above, annealing is performed, for example, at approximately 1000° C. for approximately 20 minutes.

### Insulating Film and the Like Forming Process

Next, the insulating film 22, the insulating film 23, and the step forming layer 3 are formed in this order on the silicon layer 213 as illustrated in FIG. 7C.

Each of the insulating films 22 and 23 can be formed through, for example, sputtering or CVD. The step forming layer 3 can be formed by, for example, depositing polycrystalline silicon through sputtering, CVD, or the like, doping (through ion implantation) the film with an impurity such as phosphorus or boron when necessary, and patterning the film through etching.

### Inter-Layer Insulating Film and Wiring Layer Forming Process

Next, a sacrificial layer 41, the wiring layer 62, a sacrificial layer 42, and the wiring layer 64 are formed in this order on the insulating film 23 as illustrated in FIG. 7D.

Each of the sacrificial layers 41 and 42 is partially removed through a later-described cavity portion forming process, and the remaining parts are used as the inter-layer insulating films 61 and 63. Each of the sacrificial layers 41 and 42 is formed by forming a silicon oxide film through sputtering, CVD, or the like and patterning the silicon oxide film through etching.

Each of the thicknesses of the sacrificial layers 41 and 42 is not particularly limited and is, for example, approximately between 1500 nm and 5000 nm inclusive.

Each of the wiring layers 62 and 64 is formed by, for example, forming an aluminum layer through sputtering, CVD, or the like and patterning the layer.

Each of the thicknesses of the wiring layers 62 and is not particularly limited and is, for example, approximately between 300 nm and 900 nm inclusive.

The laminated structure that is configured by the sacrificial layers 41 and 42 and the wiring layers 62 and 64 is formed by using a typical CMOS process, and the number of laminated layers is appropriately set when necessary. That is, more sacrificial layers and wiring layers may be laminated when necessary.

### Cavity Portion Forming Process

Next, the cavity portion S (cavity) is formed between the semiconductor substrate 21 and the cladding layer 641 as illustrated in FIG. 8A by partially removing the sacrificial layers 41 and 42. Accordingly, the inter-layer insulating films 61 and 63 are formed.

The cavity portion S is formed by partially removing the sacrificial layers 41 and 42 by etching through the plurality of pores 642 that is formed in the cladding layer 641. When wet etching is used as the etching, etching liquid such as hydrofluoric acid or buffered hydrofluoric acid is supplied from the plurality of pores 642. When dry etching is used, etching gas such as hydrofluoric acid gas is supplied from the plurality of pores 642. The insulating film 23 functions as an etch stop layer when the etching is performed. In addition, since the insulating film 23 has tolerance to etching liquid, the insulating film 23 has a function of protecting the components on the lower side of the insulating film 23 (for example, the insulating film 22, the piezoresistive elements 5, and the wiring system 214) from etching liquid.

The surface protective film 65 is formed through sputtering, CVD, or the like before the etching. Accordingly, the parts of the sacrificial layers 41 and 42 that are used as the inter-layer insulating films 61 and 62 can be protected when the etching is performed. Examples of the material of the surface protective film 65 include materials that have tolerance so as to protect elements from moisture, dust, scratches, and the like, such as a silicon oxide film, a silicon nitride film, a polyimide film, and an epoxy resin film. Particularly, a silicon nitride film is preferred as the material of the surface protective film 65. The thickness of the surface protective film. 65 is not particularly limited and is, for example, approximately between 500 nm and 2000 nm inclusive.

### Sealing Process

Next, the seal layer 66 that is configured by, for example, a silicon oxide film, a silicon nitride film, or a film made of metal such as Al, Cu, W, Ti, or TiN is formed on the cladding layer 641 through sputtering, CVD, or the like to seal each of the pores 642 as illustrated in FIG. 8B. Accordingly, the cavity portion S is sealed by the seal layer 66, and the laminated structure 6 is obtained.

The thickness of the seal layer 66 is not particularly limited and is, for example, approximately between 1000 nm and 5000 nm inclusive.

### Diaphragm Forming Process

Next, the recessed portion 24 is formed as illustrated in FIG. 8C by grinding the lower face of the silicon layer 211 if needed and partially removing (working) the lower face of the silicon layer 211 through etching. Accordingly, the diaphragm portion 20 is formed to face the cladding layer 641 through the cavity portion S.

The silicon oxide layer 212 functions as an etch stop layer when the lower face of the silicon layer 211 is partially removed. Accordingly, the thickness of the diaphragm portion 20 can be accurately defined.

Any of dry etching, wet etching, or the like may be used as a method for partially removing the lower face of the silicon layer 211.

According to the processes described so far, the physical quantity sensor 1 can be manufactured.

### Second Embodiment

Next, a second embodiment of the invention will be described.

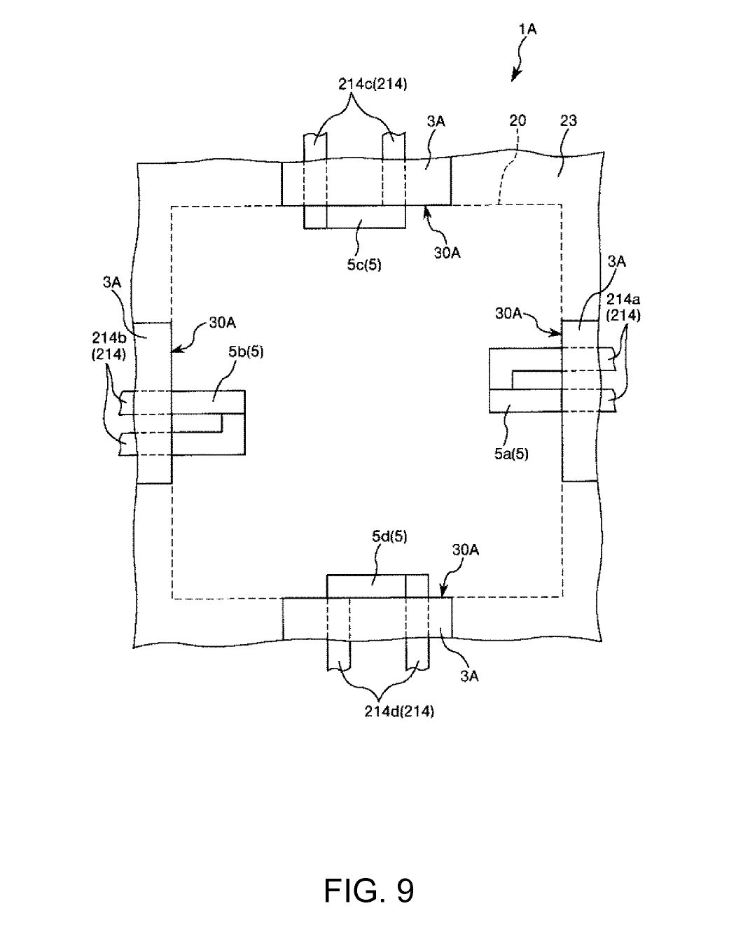

FIG. 9 is a cross-sectional view illustrating a physical quantity sensor according to the second embodiment of the invention.

Hereinafter, the second embodiment of the invention will be described by focusing on the differences from the above embodiment, and the same parts will not be described.

The second embodiment is the same as the above first embodiment except for the configuration of the ceiling portion of the cavity portion and a method for manufacturing the ceiling portion.

A physical quantity sensor 1A illustrated in FIG. 9 is provided with a step forming layer 3A that is arranged on the insulating film 23. The step forming layer 3A includes a plurality of stepped portions 30A arranged along the periphery of the diaphragm portion 20. In the present embodiment, each stepped portion 30A is disposed to correspond to only a part of each edge of the diaphragm portion 20 that is quadrangular in a plan view. That is, each stepped portion 30A is disposed to correspond to the arrangement of each piezoresistive element 5 in the present embodiment. By arranging the plurality of stepped portions 30A in this way, the stepped portions 30A impeding the flexible deformation of the diaphragm portion 20 caused by reception of pressure can be eliminated at the parts of the diaphragm portion 20 other than the parts where the piezoresistive elements 5 are arranged. Therefore, detection sensitivity can be further improved.

### 2. Pressure Sensor

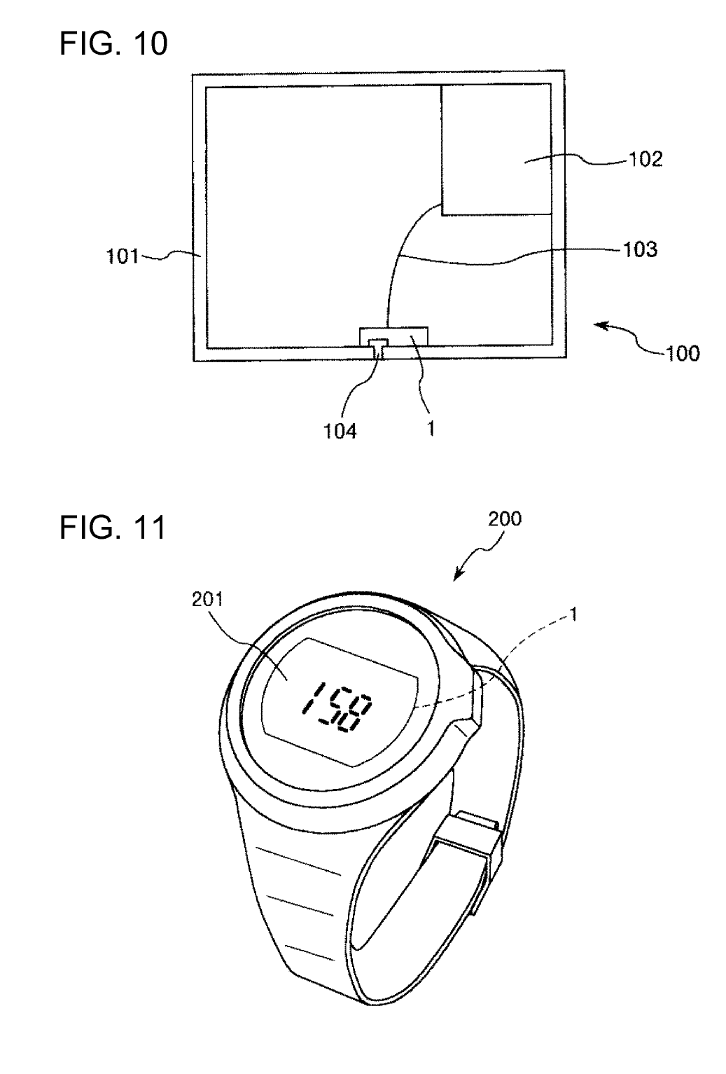

Next, a pressure sensor that is provided with the physical quantity sensor according to the invention (the pressure sensor according to the invention) will be described. FIG. 10 is a cross-sectional view illustrating an example of the pressure sensor according to the invention.

A pressure sensor 100 according to the invention, as illustrated in FIG. 10, is provided with the physical quantity sensor 1, a casing 101 that accommodates the physical quantity sensor 1, and an operation unit 102 that performs an operation for obtaining pressure data from a signal which is obtained from the physical quantity sensor 1. The physical quantity sensor 1 is electrically connected to the operation unit 102 through a wiring system 103.

The physical quantity sensor 1 is fixed inside the casing 101 by an unillustrated fixing unit. The casing 101 also includes a through hole 104 through which the diaphragm portion 20 of the physical quantity sensor 1 communicates with the atmosphere (outside of the casing 101).

According to the pressure sensor 100, the diaphragm portion 20 receives pressure through the through hole 104. The signal corresponding to the received pressure is transmitted to the operation unit through the wiring system 103, and the operation unit performs the operation on the signal to obtain the pressure data. The pressure data obtained from the operation can be displayed via an unillustrated display unit (for example, a monitor of a personal computer).

### 3. Altimeter

Next, an example of an altimeter that is provided with the physical quantity sensor according to the invention (the altimeter according to the invention) will be described. FIG. 11 is a perspective view illustrating an example of the altimeter according to the invention.

An altimeter 200 can be worn on a wrist as a wristwatch. The physical quantity sensor 1 (pressure sensor 100) is mounted in the altimeter 200. A display unit 201 can display the altitude of the current location above sea level, the atmospheric pressure of the current location, and the like.

The display unit 201 can display information such as the current time, the heart rate of a user, and weather.

### 4. Electronic Device

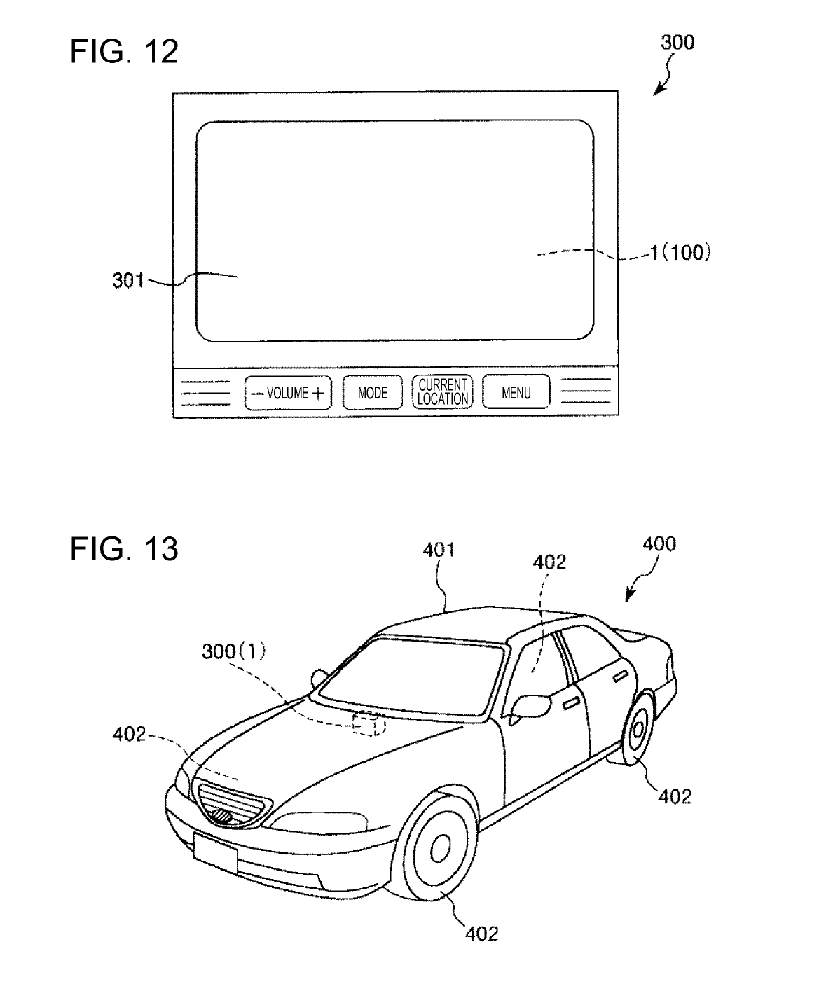

Next, a navigation system to which an electronic device provided with the physical quantity sensor according to the invention is applied will be described. FIG. 12 is a front view illustrating an example of the electronic device according to the invention.

A navigation system 300 is provided with unillustrated map information, a position information obtaining unit that obtains position information from a global positioning system (GPS), a self-contained navigation unit that includes a gyro sensor, an accelerometer, and vehicle speed data, the physical quantity sensor 1, and a display unit 301 that displays predetermined position information or course information.

According to the navigation system, altitude information can be obtained in addition to the obtained position information. A navigation system not having altitude information cannot determine whether a vehicle traverses a typical road or an elevated road when, for example, the vehicle traverses an elevated road that is represented at substantially the same position as a typical road in the position information. Thus, the navigation system provides information on the typical road to the user as prioritized information. The navigation system 300 according to the present embodiment can obtain the altitude information with the physical quantity sensor 1, can detect the altitude change that is caused by the vehicle entering an elevated road from a typical road, and can provide the user with navigation information about the state of the vehicle traversing the elevated road.

The display unit 301 has a configuration that can be reduced and thinned, such as a liquid crystal panel display and an organic electroluminescence (EL) display.

The electronic device that is provided with the physical quantity sensor according to the invention is not limited to the above one and can be applied to, for example, a personal computer, a cellular phone, a medical device (for example, an electronic thermometer, a sphygmomanometer, a blood glucose meter, an electrocardiograph, an ultrasonic diagnostic device, and an electronic endoscope), various measuring devices, meters (for example, meters in a vehicle, an airplane, and a ship), and a flight simulator.

### 5. Moving Object

Next, a moving object to which the physical quantity sensor according to the invention is applied (the moving object according to the invention) will be described. FIG. 13 is a perspective view illustrating an example of the moving object according to the invention.

A moving object 400, as illustrated in FIG. 13, includes a vehicle body 401 and four wheels 402 and is configured to rotate the wheels 402 with an unillustrated drive source (engine) that is disposed in the vehicle body 401. The navigation system 300 (physical quantity sensor 1) is incorporated into the moving object 400.

While descriptions are provided for the physical quantity sensor, the pressure sensor, the altimeter, the electronic device, and the moving object according to the invention on the basis of each illustrated embodiment so far, the invention is not limited to the embodiments. The configuration of each unit can be substituted with an arbitrary configuration that has the same function. In addition, other arbitrary constituents may be added thereto.

While the above embodiments are described with the case where the stepped portion is formed as a separate layer from the substrate that includes the diaphragm portion, the invention is not limited to this, and the stepped portion may instead be integrated with the substrate that includes the diaphragm portion.

While the above embodiments are described with the case where the number of piezoresistive elements disposed in one diaphragm portion is four, the invention is not limited to this, and the number may instead be between one and three inclusive or be greater than or equal to five. In addition, the arrangement, the shape, and the like of the piezoresistive elements are not limited to the above embodiments. The piezoresistive elements, for example, may also be arranged in the central portion of the diaphragm portion in the above embodiments.

While the above embodiments are described with the case where the piezoresistive elements are used as sensor elements that detect the flexure of the diaphragm portion, the elements are not limited to this and may be, for example, resonators.

While the above embodiments are described with the case where the pressure reference chamber is disposed on the opposite side of the substrate that includes the diaphragm portion from the side on which the recessed portion is formed, the pressure reference chamber may be formed on the face on the recessed portion side of the substrate. In this case, the pressure reference chamber can be formed by, for example, bonding another substrate to the substrate so as to close the recessed portion of the substrate.

The entire disclosures of Japanese Patent Application Nos. 2014-153665 filed Jul. 29, 2014 and 2014-153666 filed Jul. 29, 2014 are expressly incorporated herein by reference.

What is claimed is:

1. A physical quantity sensor comprising:
a substrate that includes a recess on a first side of the substrate;
a diaphragm that forms a bottom of the recess and is flexibly deformed by variations in atmospheric pressure;
a sensor operatively associated with the diaphragm; and
a step along a periphery of the diaphragm in plan view on a second side of the substrate,
the step protruding relative to the diaphragm by an amount that is less than a depth of the recess.

2. The physical quantity sensor according to claim 1,
wherein a surface of the diaphragm on the first side of the substrate is a pressure receiving face.

3. The physical quantity sensor according to claim 1,
wherein the sensor is offset toward the second side of the substrate relative to the diaphragm.

4. The physical quantity sensor according to claim 3,
wherein the sensor is positioned laterally closer to the step than to a center of the diaphragm.

5. The physical quantity sensor according to claim 1,
wherein the step is a separate layer from the substrate.

6. The physical quantity sensor according to claim 1,
wherein the separate layer includes polycrystalline silicon.

7. The physical quantity sensor according to claim 5, further comprising:
a pressure reference chamber on the second side of the substrate.

8. The physical quantity sensor according to claim 7,
wherein a side wall of the pressure reference chamber is immediately adjacent the separate layer.

9. The physical quantity sensor according to claim 1,
wherein the amount the step protrudes relative to the diaphragm is 0.1 μm to 380 μm, inclusive.

10. The physical quantity sensor according to claim 1,
wherein the diaphragm has an overall thickness of 1 μm to 8 μm, inclusive.

11. The physical quantity sensor according to claim 1,
wherein the step is −5 μm to 15 μm, inclusive, from a peripheral edge of the diaphragm toward an interior of the diaphragm.

12. The physical quantity sensor according to claim 1,
wherein the diaphragm has an overall width of 50 μm to 300 μm, inclusive.

13. A pressure sensor comprising:
a body; and
the physical quantity sensor according to claim 1 connected to the body.

14. An altimeter comprising:
a body; and
the physical quantity sensor according to claim 1 connected to the body.

15. An electronic device comprising:
a body; and
the physical quantity sensor according to claim 1 connected to the body.

16. A moving object comprising:
a body; and
the physical quantity sensor according to claim 1 connected to the body.

17. A physical quantity sensor comprising:
a substrate having first and second sides;
an open recess in the first side of the substrate;
a pressure reference chamber on the second side of the substrate;
a diaphragm having a first surface forming a bottom of the open recess and a second surface forming a ceiling of the pressure reference chamber, the diaphragm being configured to flexibly deform by variations in atmospheric pressure;
a sensor embedded in the diaphragm; and
a step along a periphery of the diaphragm, the step interconnecting the second surface of the diaphragm and a side wall of the pressure reference chamber, the step being exposed to an interior of the pressure reference chamber,
wherein the step protrudes relative to the diaphragm by an amount that is less than a depth of the open recess.

18. The physical quantity sensor according to claim 17,
wherein the sensor is positioned so as to be vertically offset toward the second side of the substrate.

19. The physical quantity sensor according to claim 18,
wherein the sensor is positioned so as to be laterally offset toward the step relative to a center of the diaphragm.

20. The physical quantity sensor according to claim 17,
wherein the step is a separate layer from the substrate.
